(19) United States
(12) Patent Application Publication
(10) Pub. No.: US 2007/0057068 A1
(43) Pub. Date: Mar. 15, 2007

(54) Portable electronic device and method for automatically switching power modes

(76) Inventor: Hsin-Feng Tsai, Pao Chiao City (TW)

Correspondence Address: RABIN & Berdo, PC, 1101 14TH STREET, NW, SUITE 500, WASHINGTON, DC, 20005, US

(21) Appl. No.: 11/366,564

(22) Filed: Mar. 3, 2006

(30) Foreign Application Priority Data
Sep. 14, 2005 (TW) 94131702

(51) Int. Cl. G06K 7/10

(52) U.S. Cl. 235/472.01

(57) ABSTRACT

A portable electronic device and method for automatically switching power modes is provided. First, detect variation of external forces applied to the portable electronic device by an accelerometer. Next, obtain a placement state of the portable electronic device according to the external force variation. Then, switch a power mode of the portable electronic device according to the placement state.

This application claims the benefit of Taiwan application Serial No. 94131702, filed Sep. 14, 2005, the subject matter of which is incorporated herein by reference.

### BACKGROUND OF THE INVENTION

1. Field of the Invention

The invention relates in general to an electronic device, and more particularly to a portable electronic device capable of automatically switching power modes, and switching method thereof.

2. Description of the Related Art

In recent years, portable computers, such as notebook or tablet PCs, are very popular in the market of electronic products and become a favorite product for the consumers. The portable computer is convenient due to its thinness and smallness. In terms of tablet computers, the user can just input information on the display panel by a touch pen without using the keyboard. Therefore, the weight of the computer can be reduced as carried by the user, thereby improving its convenience in application.

The conventional method for switching power modes in the portable computer includes manual and automatic switching methods. FIG. 1 is a schematic diagram of a conventional notebook computer. The notebook computer 100 includes an upper cover 120 and a body part 110. The body part 110 has a protrusion element 112. When the computer 100 is not used, and the upper cover 120 is closed upon the body part 110 by the user, the upper cover 120 compresses the protrusion element 112 to switch the computer to a standby mode or a sleep mode. However, this switching mode is not applicable to tablet computers.

Another method for switching power modes switches the computer system into a standby or sleep mode as the computer is in an idle state beyond a predetermined duration. However, this switching method needs a waiting duration to switch the computer back to a normal mode, thereby reducing the speed for switching power modes.

### SUMMARY OF THE INVENTION

It is therefore an object of the invention to provide a portable computer capable of automatically and conveniently switching power modes and switching method thereof.

The invention achieves the above-identified object by providing a method for automatically switching power modes applied to a portable electronic device. The portable electronic device includes an accelerometer. The method includes detecting variation of external forces applied to the portable electronic device by the accelerometer; obtaining a placement state of the portable electronic device according to the external force variation; and switching a power mode of the portable electronic device according to the placement state.

The invention achieves the above-identified object by providing a portable electronic device including an accelerometer and a processor. The accelerometer is for measuring variation of external forces applied to the portable electronic device. The processor is for obtaining a placement state of the portable electronic device according to the external force variation, and switching a power mode of the portable electronic device according to the placement state.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a schematic diagram of a conventional notebook computer.

FIG. 2 is a block diagram of the portable electronic device according to a preferred embodiment of the invention.

FIG. 3 is a flow chart of the method for automatically switching power modes according to the preferred embodiment of the invention.

### DETAILED DESCRIPTION OF THE INVENTION

In order to improve the intuition, convenience, and speed of power mode switching, the portable electronic device of the invention uses an accelerometer to detect the external force applied to the portable electronic device for determining its present placement state, and automatically switches its power mode according to the placement state.

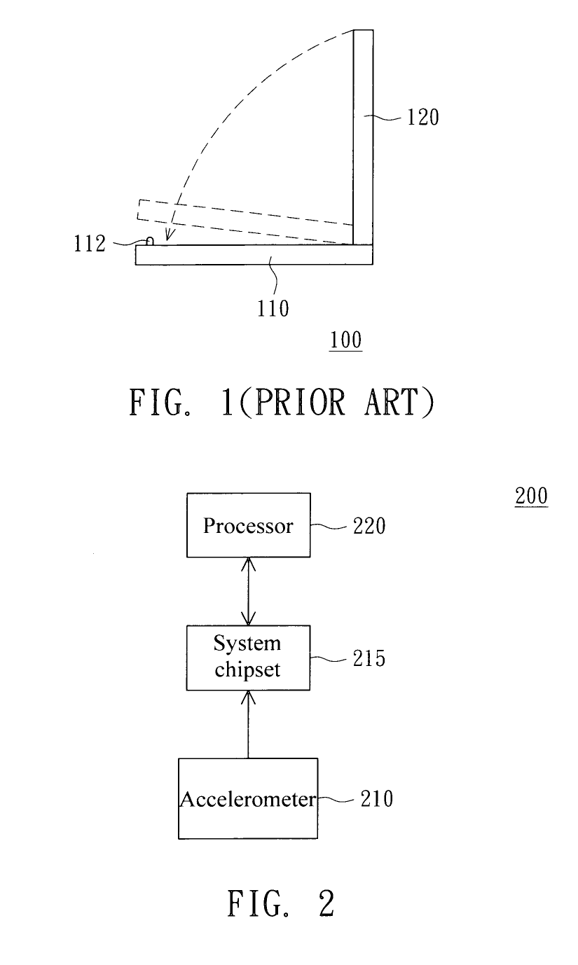

Referring to FIG. 2, a block diagram of the portable electronic device according to a preferred embodiment of the invention is shown. The portable electronic device 200 includes an accelerometer 210, a system chipset 215, and a processor 220. The accelerometer 210, for example, includes three sensors for respectively sensing the external force components applied to the portable electronic device 200 in three dimensions (x, y, z), and thus measuring the variation of external forces applied to the portable electronic device 200. The accelerometer is exemplified here to be disposed in the neighborhood of the screen of the portable electronic device 200. When the external force applied to the electronic device 200 remains a constant value, it means the portable electronic device 200 is not used by the user. If the line vertical to the screen is defined as an z axis, when the detected external force is oriented to the +z axis, it means the screen of the portable electronic device 200 faces up while it means the screen face down when the detected external force is oriented to −z axis, vice versa. The processor 220 determines the placement state of the portable electronic device 200 and thus switches the power mode of the portable electronic device 200 according to the placement state. The power mode can be a normal operation mode, a standby mode, a sleep mode and a power-off mode.

Taking a computer as an example, in the normal operation mode, the computer is in an ordinary power supply state, and supplies powers to each device in the computer. In the power-off mode, powers stop supplying to the computer. The standby mode and the sleep mode are power saving modes. Under the standby mode, the present data of the computer are stored in a memory and thus powers are supplied to the memory only. The feature of the standby mode is that it spends less time in returning to the normal operation mode than the sleep mode. In the sleep mode, the data of the memory are stored into a hard disk temporarily and then the power is stopped from supplying to the memory. Therefore, in the sleep mode, most of the devices in the computer have no power supply. As the computer is awaken from the sleep mode, the computer needs some time for transmitting the data in the hard disk back to the memory. Therefore, the sleep mode spends more time in returning to the original state than the standby mode.

The method for switching power modes can be defined according to the habit of the user. Ordinary speaking, as in a user operation, the screen of the portable electronic device 200 will not be placed in a state of facing down because the screen as facing down is inconvenient for inputting information and observing the information thereon. Therefore, the placement state of the portable electronic device 200 with the screen facing up can be defined into a user-defined range. That is, when the placement state belongs to the user-defined range, the user's sight can suitably focus on the screen. Therefore, when the screen of the portable electronic device 200 is not placed in accordance with the user-defined range for a predetermined duration, and the external force applied to the portable electronic device 200 is unchanged, the portable electronic device 200 is switched to the sleep mode or powered off.

Conversely, if the placement state of the portable electronic device 200 belongs to the user-defined range, when the portable electronic device 200 is set in an idle state and the external force applied to the device 200 is not substantially changed for a predetermined duration, the power mode of the portable electronic device 200 will be switched.

Therefore, by setting the user-defined range, the embodiment can effectively and automatically switch the power mode according to the placement state of the portable electronic device 200.

In a preferred embodiment, the processor 220 can define two predetermined durations. If the portable electronic device 200 is placed in accordance with the user-defined range, go on detecting the external force applied to the portable electronic device 200 by the accelerometer 210. When the portable electronic device 200 is under the idle state and the accelerometer 210 does not detect any external force variation for a first predetermined duration, the portable electronic device 200 is switched to a first mode, for example, from the normal operation mode to the power saving mode (the standby or sleep mode). If the electronic device 200 is set in the power saving mode and the accelerometer does not detect any external force variation for a second predetermined duration, it means the portable electronic device 200 is in a static status, the portable electronic device 200 is switched to a second mode, for example, a power-off mode. Therefore, the portable electronic device 200 of the embodiment can effectively achieve the power saving purpose.

Conversely, if the accelerometer detects an external force variation in the second duration, the power mode of the electronic device 200 is switched from the power saving mode (the standby or sleep mode) to the normal operation mode.

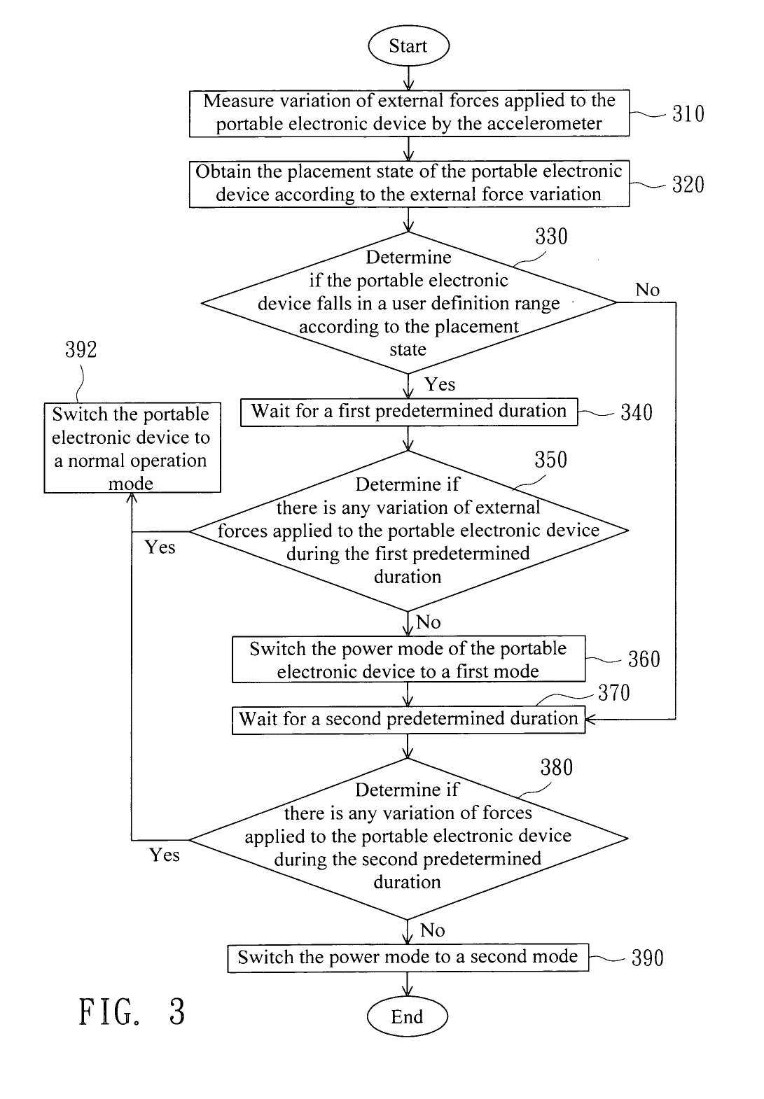

FIG. 3 is a flow chart of the method for automatically switching power modes according to the preferred embodiment of the invention. First, in step 310, measure variation of the external force applied to the portable electronic device 200 by using the accelerometer 210. Following that, in step 320, according to the external force variation, obtain the placement state of the portable electronic device 200. Next, in step 330, determine if the portable electronic device 200 is in a state within the user-defined range according to the placement state. If yes, wait for a first predetermined duration as shown in step 340. If no, wait for a second predetermined duration as shown in step 370. After the step 340, the process goes to the step 350 to determine if the accelerometer 210 detects any external force variation during the first predetermined duration. If the accelerometer does not detect any external force variation in this duration, and the portable electronic device 200 is under an idle state, proceed to the step 360 and switch the power mode of the portable electronic device 200 to a first mode, such as a power saving mode (the standby or sleep mode). If some external force variation is detected in this duration, go to the step 392 and switch the portable electronic device 200 to a normal operation mode.

After the step 360, perform the step 370 to wait in the first mode for a second predetermined duration. Next, in step 380, determine if there is any variation of the external force applied to the portable electronic device 200 during the second predetermined duration. If there is no external force variation, proceed to the step 390 and switch the power mode to a second mode, such as a power-off mode. Conversely, if there is some variation of external forces applied to the portable electronic device 200 in the step 380, switch the portable electronic device 200 to the normal operation mode, as in step 392.

The method for automatically switching power modes disclosed according to the above-mentioned embodiment of the invention, can detect the placement state of the portable electronic device by an accelerometer and automatically switch power modes of the portable electronic device accordingly. The portable electronic device can be a tablet computer, a notebook computer, or a personal digital assistant.

Besides, by the method for switching power modes, the invention can switch the portable electronic device to a power saving mode as the electronic device is static, thereby achieving the power saving purpose.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for automatically switching power modes, applied to a portable electronic device, the portable electronic device comprising an accelerometer, the method comprising:
detecting variation of external forces applied to the portable electronic device by the accelerometer;
obtaining a placement state of the portable electronic device according to the external force variation; and
switching a power mode of the portable electronic device according to the placement state.

2. The method according to claim 1, wherein the power mode comprises a normal operation mode, a standby mode, a sleep mode and a power-off mode.

3. The method according to claim 1, wherein the step of obtaining the placement state comprises determining if a front face of the portable electronic device has an orientation state within a user-defined range.

4. The method according to claim 3, wherein the step of switching a power mode of the portable electronic device comprises:
waiting for a second predetermined duration and switching the power mode of the portable electronic device if the placement state of the portable electronic device not belongs to the user-defined range.

5. The method according to claim 3, wherein the step of obtaining the placement state further comprises:
if the placement state of the portable electronic device belongs to the user-defined range, proceeding the step of detecting variation of external forces applied to the portable electronic device by the accelerometer; and
if the external forces applied to the portable electronic device are not changed in a first predetermined duration, and the portable electronic device is under an idle state, the power mode of the portable electronic device is switched.

6. The method according to claim 3, wherein the step of obtaining the placement state further comprises:
if the placement state of the portable electronic device belongs to a user-defined range, going on the step of detecting variation of external forces applied to the portable electronic device by the accelerometer;
if the accelerometer detects no external force variation for a first predetermined duration, and the portable electronic device is under an idle state, switching the portable electronic device to a first mode; and
if no external force variation is detected for a second predetermined duration as the portable electronic device is in the first mode, switching the portable electronic device to a second mode.

7. The method according to claim 6, wherein the first mode comprises a standby mode or a sleep mode.

8. The method according to claim 6, wherein the second mode comprises a power-off mode.

9. A portable electronic device, comprising:
an accelerometer, for measuring variation of external forces applied to the portable electronic device; and
a processor, for obtaining a placement state of the portable electronic device according to the external force variation, and switching a power mode of the portable electronic device according to the placement state.

10. The portable electronic device according to claim 9, wherein if the processor determines the placement state does not belong to a user-defined range, the processor switches the power mode of the portable electronic device after a second predetermined duration as there is no external force variation.

11. The portable electronic device according to claim 9, wherein the power mode comprises a normal operation mode, a standby mode, a sleep mode, and a power-off mode.

12. The portable electronic device according to claim 9, wherein if the processor determines the placement state does not belong to a user-defined range, the processor switches the portable electronic device to be powered off after waiting a second predetermined duration.

13. The portable electronic device according to claim 9, wherein if the processor determines the placement state belongs to a user-defined range, the accelerometer is continuously used to detect the variation of external forces applied to the portable electronic device and the processor switches the power mode of the portable electronic device after a first predetermined duration when there is no substantial external force variation and the portable electronic device is under an idle state.

14. The portable electronic device according to claim 9, wherein if the processor determines the placement state belongs to a user-defined range, the accelerometer is continuously used to detect the variation of external forces applied to the portable electronic device and the processor switches the portable electronic device to a first mode after a first predetermined duration when there is no substantial external force variation and the portable electronic device is under an idle state.

15. The portable electronic device according to claim 14, wherein the processor switches the portable electronic device to a second mode if the portable electronic device is under the first mode and no external force variation is detected by the accelerometer for a second predetermined duration.

16. The portable electronic device according to claim 15, wherein the first mode comprises a standby mode or a sleep mode.

17. The portable electronic device according to claim 15, wherein the second mode comprises a power-off mode.
